(19) United States
(12) Patent Application Publication
(10) Pub. No.: US 2011/0012988 A1
(43) Pub. Date: Jan. 20, 2011

(54) Telepresence System

(76) Inventors: Mark E. Gorzynski, Corvallis, OR (US); Michael D. Derocher, Corvallis, OR (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/921,352

(22) PCT Filed: Mar. 17, 2008
(86) PCT No.: PCT/US08/57274

§ 371 Date: Sep. 7, 2010

(51) Int. Cl. H04N 7/15

(52) U.S. Cl. 348/14.07; 348/E07.083

(57) ABSTRACT

Telepresence system having a media wall with one or more cameras and a participant table located a fixed distance from one or more of the cameras are useful in creating images for video conferencing. A back edge of the table is convex and a center of the back edge is aligned with a central camera. The center of the back edge is located horizontally closer to the central camera than either end of the back edge.

### BACKGROUND

Video conferencing is an established method of simulated face-to-face collaboration between remotely located participants. A video image of a remote environment is broadcast onto a local display, allowing a local user to see and talk to one or more remotely located participants.

Social interaction during face-to-face collaboration is an important part of the way people work. There is a need to allow people to have effective social interaction in a simulated face-to-face meeting over distance.

Telepresence systems are used to create large images of remote locations for video conferencing. They generally include one or more cameras for capturing an image, a display for viewing images from other locations, and a work space for seating and activities of the conference participants. Because the telepresence systems are largely responsible for the image provided to other participants, their design is crucial to effective interaction.

For the reasons stated above, and for other reasons that will become apparent to those skilled in the art upon reading and understanding the present specification, there is a need in the art for alternative telepresence systems.

### BRIEF DESCRIPTION OF THE DRAWINGS

FIG. 1 is a side view of a telepresence system in accordance with one embodiment.

FIGS. 2A-2B are top views of telepresence systems in accordance with embodiments of different seating widths.

FIGS. 3A-3B are representations of images captured from the telepresence systems of FIGS. 2A-2B, respectively.

FIG. 4 is a rear view of a participant work space in accordance with an embodiment.

### DETAILED DESCRIPTION

In the following detailed description of the present embodiments, reference is made to the accompanying drawings that form a part hereof, and in which is shown by way of illustration specific embodiments of the disclosure which may be practiced. These embodiments are described in sufficient detail to enable those skilled in the art to practice the subject matter of the disclosure, and it is to be understood that other embodiments may be utilized and that process or mechanical changes may be made without departing from the scope of the present disclosure. The following detailed description is, therefore, not to be taken in a limiting sense, and the scope of the present disclosure is defined by the appended claims and equivalents thereof.

The various embodiments involve telepresence systems including a media wall having at least one camera, and a participant work space or table located a fixed distance from the camera. The various embodiments utilize a work space shaped to mitigate distortion effects in an image captured by the camera. In concert with defined environmental characteristics of the telepresence systems, this manipulation of the image area facilitates standardized image capture across a variety of participant numbers.

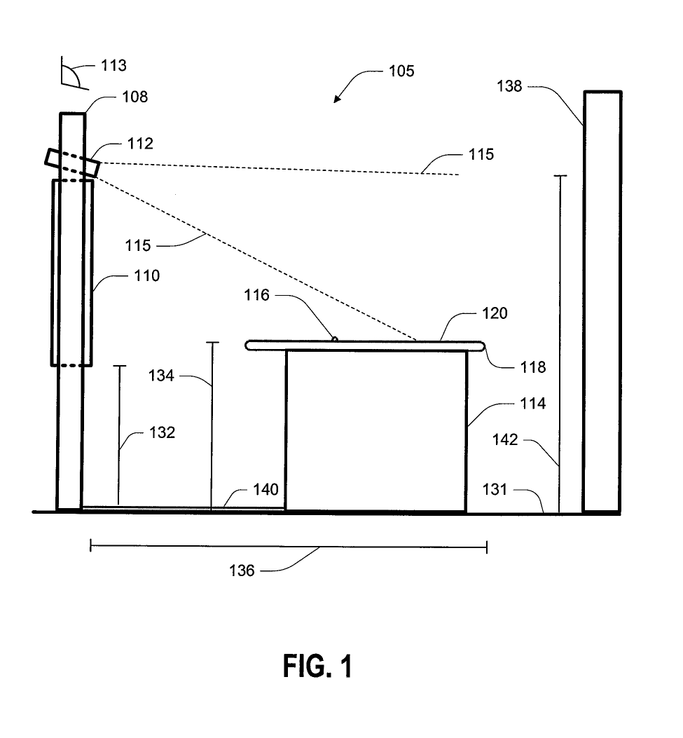

FIG. 1 is a side view of a telepresence system 105. The telepresence system 105 includes media wall having a video display 110 for displaying images from remote environments involved in a collaboration with participants using telepresence system 105, and a camera 112 for capturing an image from the telepresence system 105 for transmission to the remote environments. The media wall 108 may include other cameras (not shown) on either side of the central camera 112 for obtaining other views. The media wall 108 may further include speakers (not shown) or other means of producing audio information received from the remote environments. For one embodiment, the camera 112 is placed above the display 110. The telepresence system 105 further includes a participant work space or table 120. The components for capture and display of audio-visual information from the telepresence system 105 may be thought of as an endpoint for use in video conferencing.

The field of capture of the camera 112 is shown as dashed lines 115. Note that the field of capture 115 may be representative of the entire view of the camera 112. However, the field of capture 115 may alternatively be representative of a cropped portion of the view of the camera 112.

The display 110 is located a distance 132 above a floor 131. The media wall 108 is located a distance 136 from a back edge 118 of the table 120. The camera 112 may be positioned such that it is also located a horizontal distance 136 from the back edge 118 of the table 120, i.e., a vertical line extending from the back edge 118 is located a distance 136 from the camera 112. For one embodiment, the distance 136 is 60-90″ (152-229 cm). For a further embodiment, the distance is approximately 78″ (198 cm). The camera 112 may also be positioned at a height 142 and an angle 113 in order to obtain a field of capture that intersects the table 120 at a point forward of the back edge 118. The angle 113 is oblique to a line vertical from the floor 131 or perpendicular to a top of the table 120. For one embodiment, the angle 113 is 98-110°. For a further embodiment, the angle 113 is approximately 103°. For one embodiment, the height 142 is 50-70″ (127-178 cm). For a further embodiment, the height 142 is approximately 60″ (152 cm).

The table 120 has a support structure 114, such as rigid panels or legs, that bring it to a height 134 above the floor 131. The table 120 may be connected or attached to the media wall 108, such as by runners or struts 140, to maintain the fixed positioning of the table 120 relative to the media wall 108. Alternatively, the table 120 and media wall 108 may be fixed or attached to the floor 131 to maintain the fixed positioning. Fixing the distances between the media wall 108 and the table 120 facilitates the creation of standardized images, such that each remote location participating in a video conference would appear in a similar fashion when viewed at one of the locations. The table 120 may further include one or more audio collection devices or microphones 116 to capture audio information from participants seated at table 120. The microphones 116 may further act as reticule marks to assist in automatic adjustments of the camera 112 to the desired field of capture 115. The microphones 116 may be spaced equidistant from a center of the top surface of the table 120. An optional backdrop 138 may further be provided behind the table 120. Backdrop 138 may be a wall of a room in which the telepresence system 105 is installed. For one embodiment, the table 120 is positioned relative to the backdrop (or wall) 138 such that a seam or transition between the backdrop (or wall) 138 and the floor 131 is occluded from the field of capture 115.

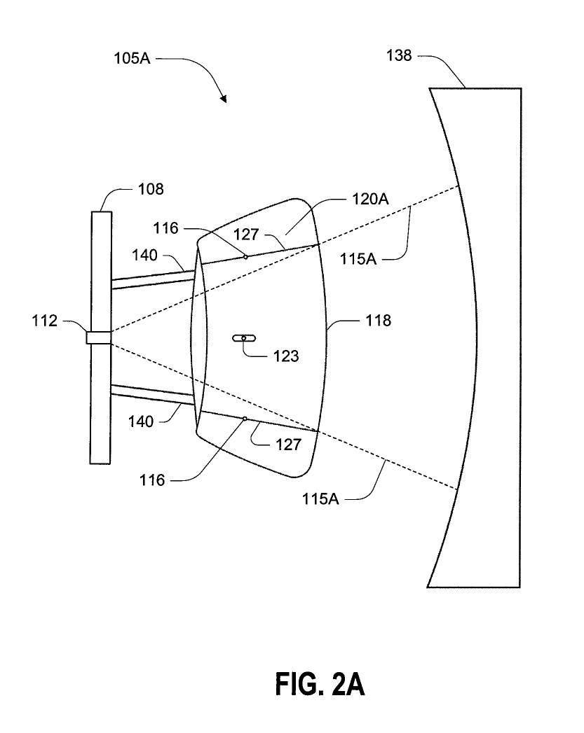

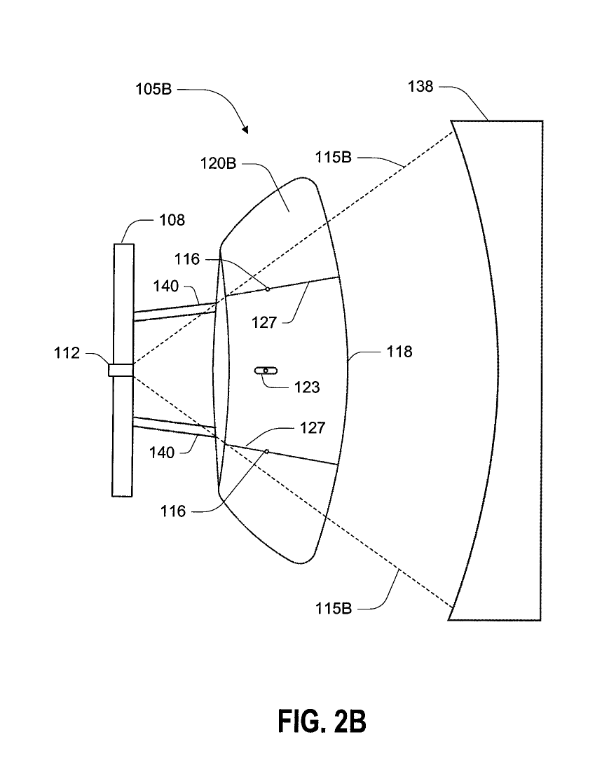

FIG. 2A is a top view of a telepresence system 105A in accordance with one embodiment having a first participant size. The telepresence system 105A might be used to capture images of two participants seated behind the table 120A. The table 120A may include a cable management holder 123 to route network cables, power cables or the like for use by participants seated behind the table 120A. The table 120A may further include lines or marks 127 to further aid in providing visual cues to the camera 112 for use in alignment and focusing. For one embodiment, the camera 112 of telepresence system 105A has at least one predefined field of capture 115A corresponding to the first participant size.

The telepresence system 105A is shown with an optional backdrop 138A. The backdrop 138A should be sized wide enough such that its edges extend beyond the field of capture 115A and high enough that its top also extends beyond the field of capture 115A in a vertical direction. By providing a neutral surface and visually unbroken surface, distractions, such as wall seams, windows, light switches, etc., may be hidden from view of the camera. Removal of such distractions from the image may provide a more pleasing image for viewing at the remote locations. The surface of the backdrop 138A should further be matted or otherwise roughened to mitigate reflections or glare. For example, the backdrop 138A could be covered in beige fabric. For another embodiment, the surface of the backdrop 138A is covered in acoustically-dampening materials to mitigate reverberation within the telepresence system 105A. Other reference numbers appearing in FIG. 2A are as described in FIG. 1.

Cameras inherently introduce distortion into the images they capture based on their field of view and focal length. Thus, a horizontal element placed below the camera would appear concave in the captured image. The table 120A may be shaped to take advantage of, and mitigate, this inherent distortion. The back edge 118 of the table 120A may be convex. Ends of the back edge 118 may be located horizontally farther from the camera 112 than a center of the back edge, tending to flatten the back edge 118 as viewed from the camera 112.

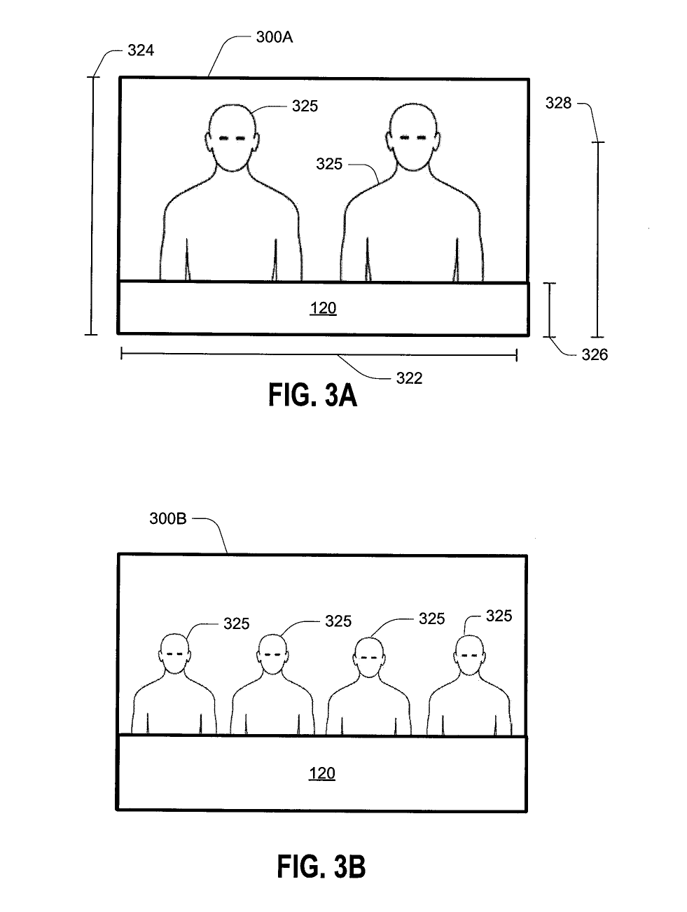

For one embodiment, the back edge 118 is shaped in response to the field of capture 115A of the camera 112 such that the back edge 118 would appear as a horizontal line when viewed by the camera 112. Thus, if a predefined field of capture 115A were selected to capture two participants 325 seated at the table 120, the image 300A may appear generally as represented in FIG. 3A.

FIG. 3A is a representation of a portal captured from the telepresence system 105A. The image 300A represents a “window” on the telepresence system 105A. The image 300A is taken along a line where the field of capture 115A intersects the table 120A. The image 300A has a foreground width 322 representing the width of the table 120A depicted in the image and a foreground height 324. The image 300A is further characterized by a table height 326, i.e., the height where the back edge 118 appears in the center of the image 300A. Although the height 326 is shown in FIG. 3A to be substantially equal across the width 322, the back edge 118 of the table 120A may appear convex or concave within the image 300A. Thus, the image 300A may be further characterized by a height of the back edge 118 at the edges of the image 300A. The image 300A may be further characterized by a presumed eye height 328 of the participants 325.

To produce a horizontal line in an image of the back edge 118 of table 120A, the curve of the back edge should be generally circular. However, due to the optics of the camera 112, the apparent radius of curvature of the back edge 118 is greater than the distance 136 from the camera 112 to the back edge 118. For one embodiment, the apparent radius of curvature of the back edge 118 is greater than two times the distance 136. For a further embodiment, the apparent radius of curvature of the back edge 118 is approximately 2.5-3 times the distance 136.

The ends of the table 120A should extend beyond the field of capture 115A, such that the ends of the table 120A do not appear in the captured image. To draw focus to the media wall 108 by participants seated at table 120A, the ends of the table 120A may extend inwardly, such that the front of the table 120A, i.e., facing the media wall 108, is more narrow than the back edge 118.

The curvature of the front of the backdrop 138A, i.e., facing the table 120A, may be shaped in response to the field of capture 115A such that the backdrop 138A appears visually as a flat wall in the image 300A. For example, the curvature of the front of the backdrop 138A may correspond to a radius of a largest of the predefined fields of capture. Thus, the curvature of the backdrop 138A should be generally circular. For one embodiment, the curvature of the backdrop 138A runs generally parallel to the curvature of the back edge 118 of table 120A. Thus, as the backdrop 138A is positioned farther from the table 120A, its radius of curvature and its width should both be increased. However, by providing a curved surface to the backdrop 138A, a width necessary to extend beyond the field of capture 115A is less than a width that would be required for a flat surface.

FIG. 2B is a top view of a telepresence system 105B in accordance with another embodiment having a second participant size larger than the first participant size. The telepresence system 105B is larger than the telepresence system 105A in that its table 120B has more seating space than table 120A. The telepresence system 105B might be used to capture images of four participants seated behind the table 120B. The table 120B may include a cable management holder 123 to route network cables, power cables or the like for use by participants seated behind table 120B. The table 120B may further include lines or marks 127 to further aid in providing visual cues to the camera 112 for use in alignment and focusing. For one embodiment, the camera 112 of telepresence system 105B has at least one predefined field of capture 115B corresponding to the second participant size. For a further embodiment, the camera 112 of telepresence system 105B has a second predefined field of capture corresponding to the field of capture 115A of the telepresence system 105A, i.e., a field of capture designed to capture two participants seated at table 120B. Similarly, the camera 112 of telepresence system 105A may have a second predefined field of capture corresponding to the field of capture 115B. However, edges of the table 120A may be captured within the image of telepresence system 105A using field of capture 115B.

The telepresence system 105B is shown with an optional backdrop 138B. The backdrop 138B should be sized wide enough such that its edges extend beyond the field of capture 115B and high enough that its top also extends beyond the field of capture 115B in a vertical direction. Other aspects of backdrop 138B are as described with reference to backdrop 138A of FIG. 2A. Other reference numbers appearing in FIG. 2B are as described in FIG. 1.

The table 120B may also be shaped to take advantage of, and mitigate, the inherent distortion of camera 112. The back edge 118 of the table 120B may thus be convex. Ends of the back edge 118 may be located farther from the camera 112 than a center of the back edge, tending to flatten the back edge 118 as viewed from the camera 112.

For one embodiment, the back edge 118 is shaped in response to the field of capture 115B of the camera 112 such that the back edge 118 would appear as a horizontal line when viewed by the camera 112. Thus, if the field of capture 115B were adjusted to capture four participants 325 seated at the table 120, the image 300B may appear generally as represented in FIG. 3B.

FIG. 3B is a representation of a portal captured from the telepresence system 105B using the field of capture 115B. The image 300B represents a “window” on the telepresence system 105B. The image 300B is taken along a line where the field of capture 115B intersects the table 120B. The image 300B has characteristics as described with reference to image 300A of FIG. 3A. Furthermore, the image 300A may represent a “window” on the telepresence system 105B when using the field of capture 115A.

To produce a horizontal line in an image of the back edge 118 of table 120B, the curve of the back edge should be generally circular. However, due to the optics of the camera 112, the apparent radius of curvature of the back edge 118 is greater than the distance 136 from the camera 112 to the back edge 118. For one embodiment, the apparent radius of curvature of the back edge 118 is greater than two times the distance 136. For a further embodiment, the apparent radius of curvature of the back edge 118 is approximately 2.5-3 times the distance 136.

The ends of the table 120B should extend beyond the field of capture 115B, such that the ends of the table 120B do not appear in the captured image. To draw focus to the media wall 108 by participants seated at table 120B, the ends of the table 120B may extend inwardly, such that the front of the table 120B, i.e., facing the media wall 108, is more narrow than the back edge 118.

The curvature of the front of the backdrop 138B, i.e., facing the table 120B, may be shaped in response to the field of capture 115B such that the backdrop 138B appears visually as a flat wall in the image 300B. Thus, the curvature of the backdrop 138B should be generally circular. For one embodiment, the curvature of the backdrop 138B runs generally parallel to the curvature of the back edge 118 of table 120B. Thus, as the backdrop 138B is positioned farther from the table 120B, its radius of curvature and its width should both be increased. However, by providing a curved surface to the backdrop 138B, a width necessary to extend beyond the field of capture 115B is less than a width that would be required for a flat surface.

Although embodiments have been described having curvatures chosen in response to the field of capture of a camera, manufacturing efficiencies may suggest compromises. For example, many of the components of the telepresence systems 105A and 105B may be the same. The tables 120A and 120B may be designed in modular fashion, and may also share components. For example, center sections of the tables between lines 127 may be the same for both tables 120A and 120B. As such, its curvature of the back edge 118 may be chosen to fall between that indicated for the field of capture 115A and the field of capture 115B. Regardless, the curvature may be chosen such that the captured image of the back edge of the table appears flatter than a straight edge would appear.

For one embodiment, the difference between different predefined fields of capture corresponds to a zoom change of the camera 112. For example, the camera 112 would merely zoom in to make a change from field of capture 115B to field of capture 115A, such that pan, tilt and roll functions of the camera 112 would not be required. For such an embodiment, camera 112 could be selected to not have pan, tilt and roll capabilities, or otherwise be precluded from performing those functions. To provide uniformity of images from each telepresence system 105, height, angle and distance of the camera 112 from the back edges 118 of tables 120 may be the same. Similarly, the height and curvature of the back edges 118 of the tables 120 may be the same for at least that portion of the tables 120 occurring in the narrower field of capture 115A. As such, an image taken from telepresence system 105B using the field of capture 115A would appear the same as an image taken from telepresence system 105A using the field of capture 115A. Other telepresence systems could be designed for other participant sizes using the teachings herein, e.g., same camera height, angle and distance, and same table height and curvature for each field of capture, such that using the same field of capture on different telepresence systems produces the same image dimensions, e.g., foreground width, foreground height and image table height. For example, a telepresence system having a participant size of six may have three predefined fields of capture, with one to capture six participants, one to capture four participants and one to capture two participants, where a curvature of its table would be the same as table 120B for at least that portion corresponding to field of capture 115B. Note that using a field of capture defined for a participant size greater than a participant size of the table may result in table edges coming into view. However, the table height within the image would be consistent. Furthermore, where the tables are wider than the selected field of capture and use consistent curvatures across the selected field of capture, the image table height at the edges of the captured images would further be consistent, allowing them to be tiled adjacent to one another to provide the impression of a single work surface for all the remote participants.

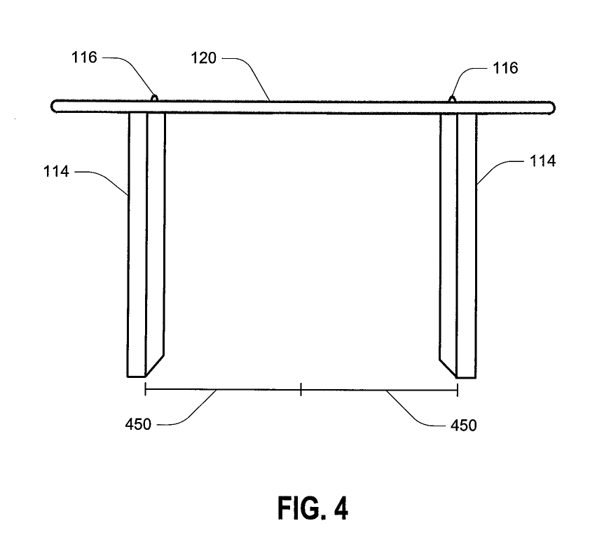

FIG. 4 is a rear view of a table 120 showing a spacing of the supports 114. To promote uniformity of captured images, it may be desirable to inhibit movement of participants seated at the table 120. For example, by extending the supports 114 to a point near the back edge 118 of a table 120, and spacing the supports 114 apart by a distance equal to two seating widths 450, participants will be encouraged to sit within the desired field of capture.

1. A telepresence system, comprising:
a media wall having one or more cameras;
a participant table located a fixed distance from one or more cameras;
wherein a back edge of the table is convex and a center of the back edge is aligned with a central camera; and
wherein the center of the back edge is located horizontally further away from the central camera than either end of the back edge.

2. The telepresence system of claim 1, wherein a curvature of the back edge is generally circular.

3. The telepresence system of claim 2, wherein a radius of curvature of the back edge is at least two times a distance from the central camera to the center of the back edge.

4. The telepresence system of claim 3, further comprising a backdrop, wherein the backdrop has a front facing the participant table, and wherein the front of the backdrop has a curvature running parallel to the curvature of the back edge of the participant table.

5. The telepresence system of claim 1, wherein the central camera is positioned at an angle of 98-108° from a line perpendicular to a top of the participant table.

6. The telepresence system of claim 1, wherein the media wall further includes a video display.

7. The telepresence system of claim 1, further comprising a backdrop.

8. The telepresence system of claim 7, wherein a surface of the backdrop facing the back edge of the participant table is covered in acoustically-dampening materials.

9. The telepresence system of claim 7, wherein the backdrop has a concave front facing the back edge of the participant table, and wherein a curvature of the front of the backdrop is generally circular.

10. The telepresence system of claim 1, further comprising struts connecting the participant table to the media wall.

11. A telepresence system, comprising:
a media wall having a camera;
a participant table having a participant size and located a fixed distance from the camera;
wherein the camera has at least one predefined field of capture corresponding to the participant size of the participant table.

12. The telepresence system of claim 11, wherein the camera has at least two predefined fields of capture with a first field of capture corresponding to the participant size of the participant table and a second field of capture corresponding to a participant size less than the participant size of the participant table.

13. The telepresence system of claim 12, wherein the first and second fields of capture correspond to first and second zoom settings of the camera.

14. The telepresence system of claim 13, wherein the camera is precluded from performing pan, tilt or roll functions.

15. The telepresence system of claim 12, wherein ends of the participant table extend beyond each of the first and second fields of capture.

16. The telepresence system of claim 11, wherein the camera has at least one predefined field of capture corresponding to a participant size greater than the participant size of the participant table.

17. The telepresence system of claim 11, further comprising a backdrop, wherein the backdrop has a front facing the participant table, and wherein the front of the backdrop has a curvature corresponding to a curvature of a largest field of capture of the at least one predefined field of capture.

18. The telepresence system of claim 17, wherein the backdrop is positioned such that a seam between the backdrop and a floor is occluded from each of the predefined fields of capture.

19. The telepresence system of claim 11, wherein a predefined field of capture corresponding to the participant size of the participant table occludes ends of the participant table.

20. The telepresence system of claim 11, further comprising struts connecting the participant table to the media wall.
